(19) United States
(12) Patent Application Publication
(10) Pub. No.: US 2025/0310732 A1
(43) Pub. Date: Oct. 2, 2025

(54) METHOD AND DEVICE FOR PROCESSING DATA ASSOCIATED WITH A SENSOR DEVICE

(71) Applicant: Robert Bosch GmbH, Stuttgart (DE)

(72) Inventors: Ali Kariminezhad, Isernhagen (DE); Frank Hofmann, Hildesheim (DE); Soheil Gherekhloo, Lauffen Am Neckar (DE)

(21) Appl. No.: 19/087,850

(22) Filed: Mar. 24, 2025

(30) Foreign Application Priority Data
Mar. 28, 2024 (DE) 10 2024 202 964.5

(51) Int. Cl. H04W 4/38; H04W 4/021; H04W 16/14

(52) U.S. Cl. CPC H04W 4/38; H04W 4/021; H04W 16/14

(57) ABSTRACT

A method for processing data associated with a sensor device. The method includes: receiving a request to transmit sensor data of the sensor device to at least one further device, wherein the request characterizes at least one property of the sensor data; providing the sensor data; sending the sensor data to the at least one further device.

### BACKGROUND INFORMATION

CPM (collective perception messages) are messages used within the collective perception concept (ETSI TR 103 562) in order to exchange information about objects between vehicles with environment sensor units. These messages contain information such as position, velocity, size and other relevant features of the recognized objects. The CPMs are generated by one vehicle and sent to other vehicles in the network in order to make collective perception of the environment possible. By exchanging CPMs, vehicles or other connected devices can expand their perception capabilities and obtain a more comprehensive picture of the traffic situation. This makes cooperative and collaborative decision-making for improved road safety and efficiency possible.

For the resource-efficient exchange of information at the object level, sensor data of various sensor units, which are arranged, for example, on the same vehicle, are fused together. However, in comparison to resource-intensive communication of raw data, essential information may get lost during the fusion prior to the message transfer.

### SUMMARY

The present invention relates to a method for processing data associated with a sensor device, in order to transfer the data in a preferably wireless communication system.

The present invention further relates to a device for processing data associated with a sensor device.

Some examples of the present invention relate to a method, for example a computer-implemented method, for processing data associated with a sensor device, in order to transfer the data in a preferably wireless communication system. According to an example embodiment of the present invention, the method includes: receiving a request to transmit sensor data of the sensor device to at least one further device, wherein the request characterizes at least one property of the sensor data; providing the sensor data; sending the sensor data to the at least one further device. In some examples, this makes it possible to provide and/or send the sensor data based on the request or the at least one property of the sensor data characterized by the request, i.e., for example, to provide and/or send the sensor data with at least one specifiable, for example desired, property.

In some examples of the present invention, the sensor device comprises, e.g., at least one of the following elements: a) radar device, or b) LIDAR device, or c) camera device. For the purpose of illustration and without limiting the generality, the following exemplary embodiments primarily relate to sensor devices comprising at least one radar device.

In some examples of the present invention, the sensor data are thus data of at least one corresponding radar device, for example raw data, e.g., at the spectrum level or spectral level, i.e., e.g., comprising one or more radar spectra as can be obtained by means of the at least one radar device.

In some exemplary embodiments of the present invention, the sensor data can characterize, e.g., a range-angle-Doppler space, wherein, for example, a cuboid, e.g., cube, (e.g., “spectrum cube”) in the range-angle-Doppler space characterizes an object that, in some examples, can be recognized, for example, by evaluating the relevant sensor data.

In some examples of the present invention, the at least one property of the sensor data is or characterizes at least one of the following elements: a) part, for example portion, or b) degree of compression, or c) resolution, for example temporal and/or spatial and/or spectral resolution.

In some examples of the present invention, the method comprises: reducing, for example filtering, the sensor data based on the request; sending the reduced sensor data, wherein sending the reduced sensor data is carried out in particular in place or instead of sending the sensor data. In some examples, this makes targeted transmission possible, e.g. of sensor data that are useful for at least one further device, e.g., a further sensor device or central unit, e.g. for an evaluation, e.g., a joint evaluation, e.g. together with sensor data of the at least one further device. At the same time, reducing, e.g., filtering, can reduce a data volume for sending, e.g., transmitting.

In some examples of the present invention, the method comprises: ascertaining a filter function based on the request, for example based on the at least one property; using the filter function, for example for a or the reduction of the sensor data.

In some examples of the present invention, the method comprises: ascertaining a first filter rate, for example for Doppler spectrum sharing; and, optionally, filtering the sensor data based on the first filter rate.

In some examples of the present invention, the method comprises: ascertaining a second filter rate, for example for range-angle spectrum sharing; and, optionally, filtering the sensor data based on the second filter rate.

Within the framework of the present invention, a filter rate can be understood as a variable, in particular a parameter or a parameter set, which represents or characterizes and/or correlates with a measure or a strength or an extent of a reduction or filtering of the sensor data. Preferably, a measure represents or characterizes a loss or decrease, caused by the reduction or filtering, in information contained in the sensor data.

For example, a first parameter can define, represent or characterize a loss of range-angle information, a second parameter can define, represent or characterize a loss of Doppler-frequency information, and a third parameter can define, represent or characterize a loss of (azimuth)-angle information. A fourth parameter can define, represent or characterize a loss of (elevation)-angle information. It is possible that the filter rate is specified or can be specified per object of the sensor data or individually for each object.

In other words, the filter rate preferably indicates how (un)important the sensor data (in particular raw data) are for other sensor units/vehicles. The more important or relevant the sensor data, the lower the filter rate and, accordingly, the lower the loss of information. The more unimportant or irrelevant the sensor data, the greater the filter rate and, accordingly, the greater the loss of information.

For example, with a filter rate for object “I” of 0.5 for the range and/or the angle and with a filter rate for object “I” of 0.75 for the Doppler frequency, only every second sensor value along an angular axis and only every fourth sensor value along a Doppler frequency axis can be transferred to other vehicles/sensor units. In other words, every second sensor value along the angular axis and three out of four sensor values along the Doppler frequency axis are removed before the transfer (by means of a preferably wireless communication system).

Further examples of the present invention relate to a method, for example a computer-implemented method, for processing data associated with a sensor device, in order to transfer the data in a preferably wireless communication system, comprising: sending, to the sensor device, a request to transmit sensor data of the sensor device to at least one further device, wherein the request characterizes at least one property of the sensor data; receiving the sensor data; and, optionally, processing the received sensor data.

In some examples of the present invention, the at least one property of the sensor data is and/or characterizes at least one of the following elements: a) part, for example portion, or b) degree of compression, or c) resolution, for example temporal and/or spatial and/or spectral resolution.

In some examples of the present invention, the method comprises: forming the request based on at least one of the following elements: a) information regarding neighboring sensor devices, or b) specifiable area, for example area of interest, or c) environment model; and, optionally, sending the request.

In some examples of the present invention, the method comprises: forming a plurality of requests, each for different sensor devices, based on at least one of the following elements: a) information regarding neighboring sensor devices, or b) specifiable area, for example area of interest, or c) environment model; sending the plurality of requests to the different sensor devices.

In some examples of the present invention, the method comprises: receiving sensor data from the different sensor devices; and, optionally, evaluating, for example jointly evaluating, the received sensor data.

Further examples of the present invention relate to a device for carrying out the method according to the examples.

Further examples of the present invention relate to a product, for example a sensor device and/or a central unit, comprising at least one device according to the examples. The product is preferably part of a vehicle, e.g., a car, a truck, an e-bike. It is also possible that the product is part of or designed as a portable end device such as a smartphone.

Further examples of the present invention relate to a computer-readable storage medium comprising commands that, when executed by a computer, cause said computer to perform the method according to the examples.

Further examples of the present invention relate to a computer program comprising commands that, when the program is executed by a computer, cause said computer to perform the method according to the examples.

Further examples of the present invention relate to a data carrier signal that transfers and/or characterizes the computer program according to the examples.

Further examples of the present invention relate to a use of the method according to the examples and/or of the device according to the examples and/or of the product according to the examples and/or of the computer-readable storage medium according to the examples and/or of the computer program according to the examples and/or of the data carrier signal according to the examples for at least one of the following elements: a) transferring sensor data, for example raw data, of at least one sensor device, or b) selecting parts of sensor data, for example raw data, or c) requesting sensor data, for example raw data, or d) processing, for example joint processing, of sensor data, for example raw data, for example of a plurality of sensor devices, or e) coordinating a processing of sensor data, for example raw data, for example of a plurality of sensor devices.

Further features, possible applications, and advantages of the present invention will be apparent from the following description of examples shown in the figures. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified flow diagram, according to an example embodiment of the present invention.

FIG. 2 schematically shows a simplified block diagram, according to an example embodiment of the present invention.

FIG. 3 schematically shows a simplified flow diagram, according to an example embodiment of the present invention.

FIG. 4 schematically shows a simplified flow diagram, according to an example embodiment of the present invention.

FIG. 5 schematically shows a simplified flow diagram, according to an example embodiment of the present invention.

FIG. 6 schematically shows a simplified flow diagram, according to an example embodiment of the present invention.

FIG. 7 schematically shows a simplified flow diagram, according to an example embodiment of the present invention.

FIG. 8 schematically shows a simplified flow diagram, according to an example embodiment of the present invention.

FIG. 9 schematically shows a simplified flow diagram, according to an example embodiment of the present invention.

FIG. 10 schematically shows a simplified block diagram, according to an example embodiment of the present invention.

FIG. 11 schematically shows a simplified block diagram, according to an example embodiment of the present invention.

FIG. 12 schematically shows a simplified block diagram, according to an example embodiment of the present invention,

FIG. 13 schematically shows a simplified block diagram, according to an example embodiment of the present invention.

FIG. 14 schematically shows aspects of uses, according to example embodiments of the present invention.

### DETAILED DESCRIPTION OF EXAMPLE EMBODIMENTS

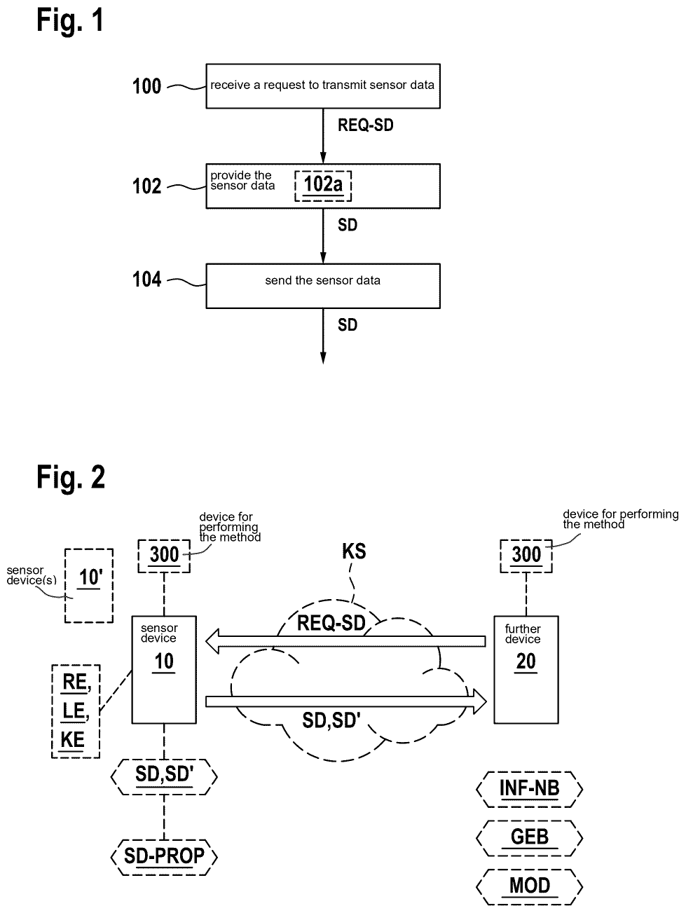

Some examples, FIG. 1, 2, relate to a method, for example a computer-implemented method, for processing data associated with a sensor device 10, in order to transfer the data in a preferably wireless communication system, comprising: receiving 100 a request REQ-SD to transmit sensor data SD of the sensor device 10 to at least one further device 20, wherein the request characterizes at least one property SD-PROP of the sensor data SD; providing 102 the sensor data SD; sending 104 the sensor data SD to the at least one further device 20. In some examples, this makes it possible to provide 102 and/or send 104 the sensor data SD based on the request REQ-SD or the at least one property SD-PROP of the sensor data characterized by the request, for example to provide and/or send the sensor data with at least one specifiable, for example desired, property.

In other words, e.g., a device sending the request REQ-SD can select how the at least one property of the sensor data to be provided and/or sent should be designed or how the sensor data to be provided and/or sent should be designed, by specifying the request REQ-SD, for example by specifying the at least one property SD-PROP of the sensor data SD. For example, providing 102 can therefore comprise providing the sensor data according to the at least one property SD-PROP.

In some examples, FIG. 2, the sensor device 10 comprises, e.g., at least one of the following elements: a) radar device RE, or b) LIDAR device LE, or c) camera device KE. In some examples, at least one of the components RE, LE, KE is, e.g., at least temporarily a source of the sensor data SD.

In some examples, FIG. 2, the further device 20 is, e.g., also a sensor device, or a central unit, or, e.g., a sensor device that can at least temporarily perform a function of a central unit, wherein this function of a central unit can, e.g., comprise aggregating at least some sensor data of a plurality of sensor devices 10, 10′, 20.

For the purpose of illustration and without limiting the generality, the following exemplary embodiments primarily relate to sensor devices 10, 10′ comprising at least one radar device RE.

In some examples, FIG. 2, the sensor data SD are thus data of at least one corresponding radar device RE, for example raw data, e.g. at the spectrum level or spectral level, i.e., e.g., comprising one or more radar spectra as can be obtained by means of the at least one radar device RE. This applies analogously in other examples with differently designed sources LE, KE of sensor data SD.

In some exemplary embodiments, FIG. 2, the sensor data SD can characterize, e.g., a range-angle-Doppler space, wherein, for example, a cuboid, e.g., cube, (e.g., “spectrum cube”) in the range-angle-Doppler space characterizes an object that, in some examples, can, e.g., be recognized by evaluating the relevant sensor data.

In some examples, FIG. 2, the at least one property SD-PROP of the sensor data SD is or characterizes at least one of the following elements: a) part, for example portion (e.g., in terms of time and/or space and/or spectrum), or b) degree of compression, or c) resolution, for example temporal and/or spatial and/or spectral resolution. For example, by specifying a corresponding request REQ-SD, it can thus be defined which part of the sensor data SD, e.g. of the sensor device 10, is to be provided or sent, and/or with which degree of compression the sensor data SD or, if applicable, the corresponding part of the sensor data SD is to be provided or sent, and/or with which resolution (e.g., temporal and/or spatial and/or spectral resolution) the sensor data SD or, if applicable, the corresponding part of the sensor data SD is to be provided or sent. As a result, in some examples, the parts of the sensor data SD of the sensor device 10 that are useful, e.g. for a joint evaluation with further sensor data, e.g., of other sensor devices 10′, 20 can be flexibly and precisely requested for provision or transmission, e.g. to the further device 20, wherein, e.g., the parts of the sensor data SD of the sensor device 10 that are less useful (e.g., due to redundancy, comparatively low information content) are not requested for the relevant joint evaluation and are therefore also not provided and sent, which saves, e.g., resources of a communication medium that can be used for sending.

In some examples, FIG. 2, the transmission of the request REQ-SD and/or the sending 104 of the sensor data SD is carried out by means of a, for example wireless, for example cellular or Wi-Fi-based, communication system KS, for example compatible with or based on a standard, e.g., of type 4G or 5G or 6G or another documentation or another standard. Preferably, the communication system is designed as a V2V communication system and is configured to make indirect or direct vehicle-to-vehicle communication possible.

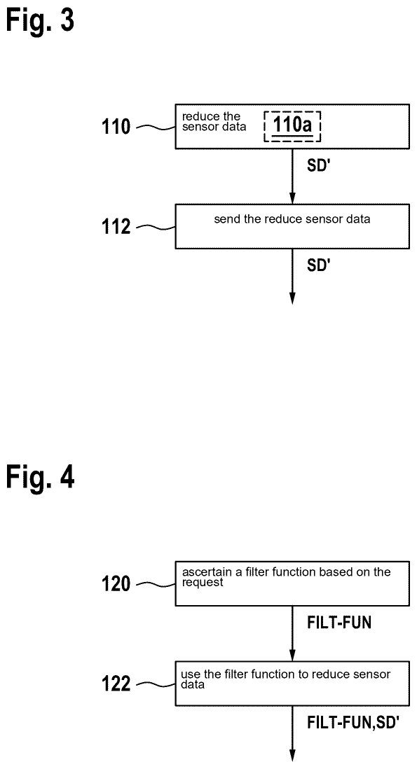

In some examples, FIG. 3, the method comprises: reducing 110, for example filtering 110a, the sensor data SD based on the request REQ-SD; sending 112 the reduced sensor data SD′. In some examples, this makes targeted transmission possible, e.g. of sensor data SD′ that are useful for at least one further device 20, e.g., a further sensor device or central unit, e.g. for an evaluation, e.g., a joint evaluation, e.g. together with sensor data of the at least one further device 20 (and/or at least one further sensor device 10′). For example, reducing 110, e.g., filtering 110a, can reduce a data volume for sending 104, 112, e.g., transmitting, which can save resources of the communication system KS.

In some examples, FIG. 1, the reduction, e.g., filtering, can be carried out, e.g., as part of the provision 102, see the optional block 102a.

In some examples, FIG. 4, the method comprises: ascertaining 120 a filter function FILT-FUN based on the request REQ-SD (FIG. 2), for example based on the at least one property SD-PROP; using 122 the filter function FILT-FUN, for example for a or the reduction 110 of the sensor data, which results in reduced sensor data SD′.

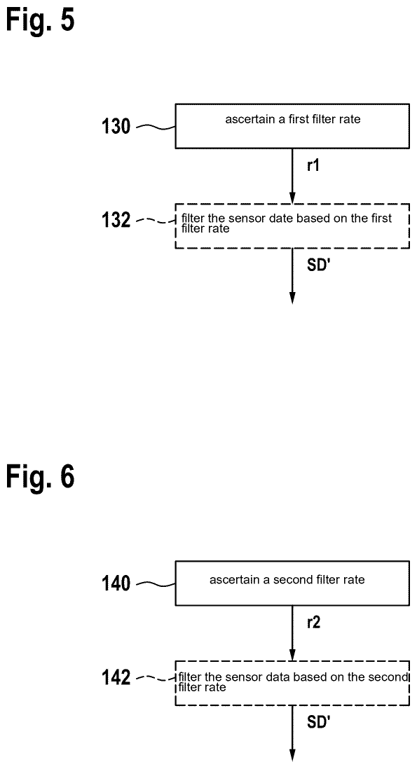

In some examples, FIG. 5, the method comprises: ascertaining 130 a first filter rate r1, for example for Doppler spectrum sharing; and, optionally, filtering 132 the sensor data SD based on the first filter rate r1. In some examples, the request REQ-SD can specify, for example, whether Doppler spectrum sharing should be used or whether and/or how the first filter rate r1 should be ascertained.

In some examples, FIG. 6, the method comprises: ascertaining 140 a second filter rate r2, for example for range-angle spectrum sharing; and, optionally, filtering 142 the sensor data SD based on the second filter rate r2. In some examples, the request REQ-SD can specify, for example, whether range-angle spectrum sharing should be used or whether and/or how the second filter rate r2 should be ascertained.

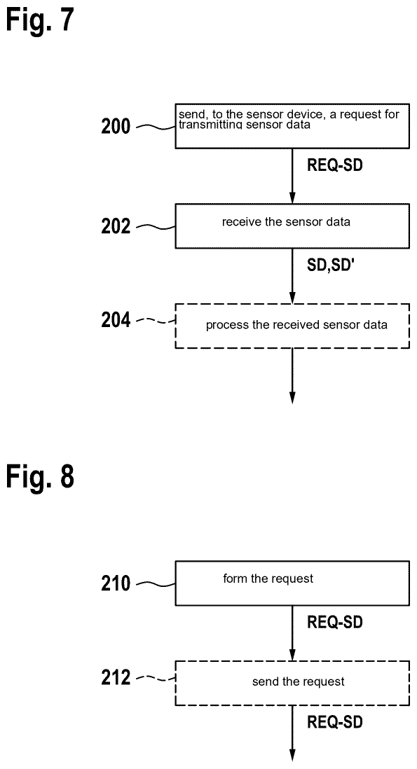

Further examples, FIG. 2, 7, relate to a method, for example a computer-implemented method, for processing data associated with a sensor device 10 (FIG. 2), in order to transfer the data in a preferably wireless communication system, comprising: sending 200 (FIG. 7), to the sensor device 10, a request REQ-SD for transmitting sensor data SD of the sensor device 10 to at least one further device 20, wherein the request REQ-SD characterizes at least one property of the sensor data SD; receiving 202 the sensor data SD (if applicable, in a form SD′ reduced based on the request REQ-SD); and, optionally, processing 204 the received (if applicable, reduced) sensor data SD, SD′, for example as part of a joint evaluation of (e.g., reduced) sensor data of a plurality of sensor devices 10, 10′, 20.

In some examples, the at least one property SD-PROP of the sensor data, as described above, is and/or characterizes at least one of the following elements: a) part, for example portion, or b) degree of compression, or c) resolution, for example temporal and/or spatial and/or spectral resolution.

In some examples, FIG. 2, 8, the method comprises: forming 210 the request REQ-SD based on at least one of the following elements: a) information INF-NB regarding neighboring sensor devices 10′, or b) specifiable area, for example area of interest, GEB (e.g., environment of at least one of the devices 10, 10′, 20), or c) environment model MOD; and, optionally, sending 212 the request REQ-SD.

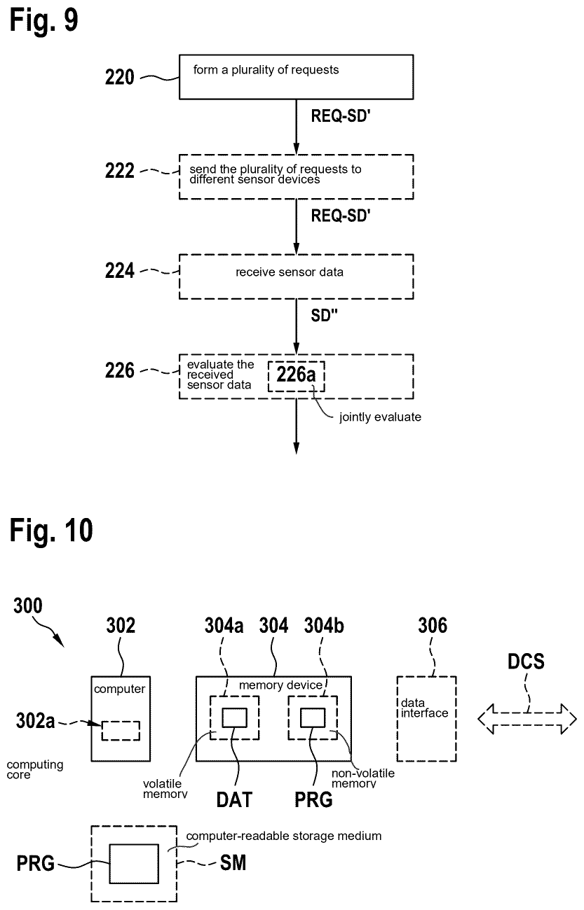

In some examples, FIG. 9, the method comprises: forming 220 a plurality of requests REQ-SD′, each for different sensor devices 10, 10′ (FIG. 2), based on at least one of the following elements: a) information INF-NB regarding neighboring sensor devices, or b) specifiable area, for example area of interest, GEB, or c) environment model MOD; sending 222 at least one, e.g., all, of the plurality of requests REQ-SD′ to the different sensor devices 10, 10′.

In some examples, FIG. 9, the method comprises: receiving 224 sensor data SD″ from the different sensor devices 10, 10′; and, optionally, evaluating 226, for example jointly evaluating 226a, the received sensor data SD″.

Further examples, FIG. 10, relate to a device 300 for performing the method according to the examples.

In some examples, the device 300 is designed to perform aspects of the method for the sensor device 10, for example at least one aspect as described above by way of example with reference to FIG. 1 to 6.

In some examples, the device 300 is designed to perform aspects of the method for the further device 20, for example at least one aspect as described above by way of example with reference to FIG. 2, 7 to 9.

In some examples, the device 300 is designed to perform aspects of the method for the sensor device 10 as well as aspects of the method for the further device 20.

In some examples, FIG. 10, the device 300 comprises: a computing device (“computer”) 302 comprising at least one computing core 302a, a memory device 304, assigned to the computing device 302, for at least temporarily storing at least one of the following elements: a) data DAT, b) computer program PRG, for example for performing the method according to the examples.

For example, the data DAT characterize at least one of the following elements: a) sensor data SD, SD″, or b) reduced sensor data SD′, SD″, or c) request REQ-SD, REQ-SD′, or d) filter function FILT-FUN, or e) filter rate r1, r2.

In further examples, the memory device 304 has a volatile memory (e.g. a random access memory (RAM)) 304a, and/or a non-volatile (NVMV) memory (e.g. a flash EEPROM) 304b, or a combination thereof or with other types of memory not explicitly mentioned.

Further examples relate to a computer-readable storage medium SM comprising commands PRG that, when executed by a computer 302, cause said computer to perform the method according to the examples.

Further examples relate to a computer program PRG comprising commands that, when the program PRG is executed by a computer 302, cause said computer to perform the method according to the examples.

Further examples relate to a data carrier signal DCS that characterizes and/or transfers the computer program PRG according to the examples. The data carrier signal DCS can be transmitted, e.g., received and/or sent, for example, via an optional data interface 306 of the device 300. Likewise, e.g., the data DAT, or at least some aspects or parts of the data DAT, such as SD, SD′, SD″, REQ-SD, can be transferred or transmitted (sent and/or received) via the optional data interface 306.

In further examples, the communication with a further unit 10, 10′, 20 (FIG. 2) can be carried out, e.g., via the communication system KS, e.g., via the optional data interface 306.

Further examples, FIG. 2, relate to a product, for example a sensor device, 10, 10′, 20 and/or a central unit 20, comprising at least one device 300 according to the examples.

Further aspects and examples are described below, which can each be combined individually or in any combination with one another with at least one of the examples and/or aspects described above by way of example.

In some examples, a reliable, for example robust, perception, for example of objects in the area of the sensor devices 10, 10′, 20 (FIG. 2), can be ensured by exchanging information between the sensor devices 10, 10′, 20 according to the examples, e.g., by means of the request REQ-SD for sensor data and their, e.g., partial transmission or a transmission of reduced sensor data SD′.

In some examples, e.g., blind spots and corners can be covered by the joint processing, for example evaluation, of sensor data SD″ of a plurality of sensor devices 10, 10′.

In some examples, FIG. 2, the sensor devices 10, 10′, 20 are used, e.g. due to robustness, e.g. in different weather conditions, with radar devices or radar sensors RE as data sources for the sensor data SD, for example for vehicles, e.g., autonomous vehicles, and/or for an infrastructure, e.g., for infrastructure components such as roadside units, and/or networks.

In some examples, e.g. environmentally relevant information can be exchanged between the sensor devices 10, 10′, 20 or their radar devices or radar sensors RE, e.g. in the following forms:
a) grouped, for example clustered, point cloud at the object level (e.g., a single point represents an object or an object is represented as a point (e.g., clustered point cloud) or bounding box, e.g., with comparatively sparse data (i.e., e.g., data of comparatively low density)),
b) raw detected point clouds (e.g., a plurality of points represent one object, e.g., with sparse object data),
c) raw data at the spectrum level or spectral level (e.g., a cuboid, e.g., spectrum cube, in the range-angle-Doppler space represents an object, e.g., in the case of comparatively dense data).

In some examples, FIG. 2, sensor data SD, SD′ can be exchanged between the sensor devices 10, 10′, 20, e.g., by exchanging point clouds at the object level, for example by means of a so-called CPM (collective perception message). In some examples, e.g. due to their comparatively small data volume, the CPMs do not represent a major load for communication connections, for example of the communication system KS.

In some examples, e.g. with a given a constant error alarm rate, a point cloud can be generated, for example, by means of a CFAR algorithm, and the point cloud can be exchanged, for example, between at least some sensor devices 10, 10′, 20. In some examples, e.g., the radar units or radar devices RE can then, e.g., use the points of other sensor devices to form clusters and/or to perform, e.g., any type of fusion, for example data fusion, which can also be supported by AI (artificial intelligence) in some examples.

In some examples, for example with respect to some of the aspects mentioned above, e.g. an association of detected points of a plurality of, for example all, sensor devices can, for example be problematic, for example when a coordinate exchange is not error-free, e.g. due to a sensor position of a sensor device.

In some examples, for example with respect to some of the aspects mentioned above, e.g., object-level detection can, e.g., only detect part of the object information. In some approaches, this can be achieved, e.g., mainly by CFAR, e.g., on the basis of adaptive threshold value calculation at the local level, and can have disadvantages with regard to the creation of object hypotheses in comparison to other approaches.

In some examples, for example, sensor data SD, SD′ are therefore exchanged between the sensor devices 10, 10′, 20, e.g. in the form of, e.g., dense, raw data, for example at the spectrum level, which in some examples can increase, e.g., a reliability of an evaluation and provide comparatively informative evaluation results.

In some examples, transmission of the sensor data SD in the form of raw data, e.g., at the spectrum level, requires a comparatively large channel capacity, e.g. of the communication system KS (FIG. 2), for reliable communication between the sensor devices 10, 10′, 20. In addition, such an exchange of raw data as sensor data may be limited, e.g. due to a limitation of the resources of the communication system KS, and may be further impaired, e.g. with an increasing number of sensor devices that exchange sensor data and, e.g., share their spectra.

The principle according to the disclosure therefore advantageously makes it possible to exchange sensor data SD, SD′, e.g., in the sense of an exchange of partial raw data, wherein a part of the sensor data that is to be transmitted, e.g., in the form of raw data, can, for example, be specified, e.g. by means of the request REQ-SD (FIG. 2, 3). This allows, e.g., parts of sensor data of interest, e.g., in the form of raw data, e.g. of a radar device RE, to be requested dynamically (e.g., during operation) and exchanged via the communication system KS. For example, in some examples, an amount of sensor data to be transferred can be adapted to a current workload of the communication system KS.

In some examples, the principle according to the disclosure makes shared use, e.g., of raw data of the sensor devices 10, 10′, 20, e.g., by at least one user, possible, e.g. such that a perception by means of the sensor devices 10, 10′, 20 is improved and, e.g., at the same time, the load on at least one communication channel of the communication system KS is kept as low as possible.

In some examples, it is therefore proposed to use the request REQ-SD to transmit the sensor data, e.g., in the form of raw data (e.g., spectral information, e.g., of a radar device RE), e.g., to inform the sensor device 10 about which part of the sensor data is to be transferred and, optionally, if applicable, with which properties.

In some examples, for example, this can be used to provide, e.g., an “intelligent” request for raw data, e.g., taking into account a need regarding the sensor data and the communication quality, for example in the further device 20 (FIG. 2).

In some examples, the unit creating the request REQ-SD, e.g., the device 20, can form the request, e.g., using context information such as CPM, CAM (cooperative awareness message) and/or knowledge, e.g., from a digital twin, e.g., about a position of other sensor devices 10, 10′. In some examples, e.g. on the basis of this information, a quality of the observation by other sensor devices (e.g., by means of their radar devices) can be estimated.

In some examples, it can be provided to evaluate an additional benefit of using information, such as the sensor data, of other sensor devices, e.g., before the request REQ-SD is created. For example, if the evaluation shows that the additional benefit from sensor data of other sensor devices is comparatively small, it is possible to refrain from requesting these sensor data of the other sensor devices by means of the request REQ-SD. For example, if the evaluation shows that the additional benefit from sensor data of other sensor devices is comparatively large, these sensor data of the other sensor devices can be requested by means of the request REQ-SD.

FIG. 11 shows elements of a system according to some examples in a schematically simplified manner. Shown are, by way of example, a plurality of sensor devices N1, N2, N3, NK (for example, at least similar to the sensor devices 10, 10′, 20 according to FIG. 2) and a central unit C, along with an object, for example target object, t, which can be detected, for example, by at least some of the plurality of sensor devices N1, N2, N3, NK, for example by means of a corresponding radar device (not shown in FIG. 11, see, e.g., element RE of FIG. 2). For the sake of simplicity, the examples according to FIG. 11 are described for a single target t, although the aspects described below can easily be extended according to further examples to scenarios with more than one target t.

In some examples, FIG. 11, it is assumed that the sensor devices N1, N2, N3, NK observe the target t in their field of view. In addition, the sensor devices N1, N2, N3, NK can, for example, also communicate with one another via a communication system, see, e.g., element KS according to FIG. 2. For this purpose, the sensor devices N1, N2, N3, NK can, e.g., have corresponding communication devices, which are not shown for reasons of clarity. In some examples, it can also be provided that the sensor devices N1, N2, N3, NK are designed to perform methods for, e.g., integrated communication and sensing.

In some examples, FIG. 11, at least some of the sensor devices N1, N2, N3, NK are stationary, e.g., associated with an element of an infrastructure (e.g., road sign, traffic light, etc.). In some examples, FIG. 11, at least some of the sensor devices N1, N2, N3, NK are mobile, e.g., associated with a mobile product such as a vehicle or mobile phone or the like.

In some examples, FIG. 11, the central unit C is designed to perform a detection of the target object t as precisely as possible, for example perfectly. The central unit C can, e.g., be a fixedly installed node in the infrastructure or a mobile user. Furthermore, in some examples, the central unit C can perform its own observation of the target (e.g., by means of at least one of its own sensor devices or radar devices or the like), or, in some other examples, may not.

In some examples, the central unit C is designed to combine available detection information (e.g., in the form of sensor data of the sensor devices N1, N2, N3, NK (and/or of itself, e.g., of a radar device (not shown) of the central unit C)) in order to obtain a better observation of the target object t, e.g., by means of a joint evaluation of the sensor data of the plurality of devices N1, N2, N3, NK, C.

In some examples, at least some of the following items of information or aspects I1, I2, I3 are fully or at least partially known to the central unit C or are ascertained or transmitted to the central unit C:

Aspect I1. State of the sensors: e.g., position and trajectory of the sensor devices N1, . . . , NK are known to the central unit C. In addition, in some examples, the central unit C knows whether or not the sensor devices N1, . . . , NK have the target object t in their field of view. In some examples, e.g. additional, information about the capabilities or properties of the sensor devices is available. This information can, e.g. in ICAS (integrated communication and sensing), be the bandwidth of the detection, the number of antennas, etc. This information can, e.g., be transmitted directly by the sensor devices to the central unit C (e.g., using a message such as CPM, CAM, . . . ), or it can be provided by a digital twin (not shown) of the relevant sensor device. In some examples, e.g., in the case of ICAS, at least some of the mentioned items of information can be known or ascertained, e.g., from a MAC layer and/or physical (“PHY”) layer, e.g., a secondary connection, and/or a configuration of the network, e.g., communication system KS, and/or a base station and/or a core network.

Aspect I2. Region of interest: In some examples, for example, the central unit C knows, e.g., either an approximate position of the target object t or is, e.g., interested in a better perception of a certain area.

Aspect I3. Available environment model: The central unit C obtains or, in some examples, has a first estimate of the environment to be monitored. This first estimate can be obtained, e.g., by a fusion of CPMs of other sensor devices and/or in a simulation-based manner, e.g., by means of at least one digital twin and/or by means of ray tracing (e.g., in the case of radio-based detection) and/or by the central unit C's own sensors.

In some examples, at least some items of information of the aspects I1, I2, I3 described above by way of example may be unavailable at least temporarily. Nevertheless, in some examples, the principle according to disclosure can also be applied in such situations.

In some examples, FIG. 11, the central unit C ascertains, e.g., estimates, the quality of the sensor data from at least some, e.g., all, sensor devices N1, N2, N3, NK, e.g. for a relevant region, e.g. on the basis of the position and the state of the sensor devices known to the central unit C. In some examples, the central unit can use, e.g., a model of a detection channel (e.g., ray tracing), e.g. in order to determine a filter rate for the sensor data, e.g., raw data. In some examples, the central unit C generates, e.g., a series of items of information of other sensor devices from the perspective of a region of interest (e.g., a field in the entire detection range/spectrum). In some examples, this can be achieved, e.g., with the aid of a-priori information about the state of the sensor devices (e.g., according to aspect I1) and an available local environment model (e.g., according to aspect I3).

In some examples, based on the aforementioned information, an instruction, for example a rule of thumb, for determining at least one of the following aspects results: —quality of the sensor data acquired by other sensor devices, —correlation of at least some, for example all, sensor data. For example, in some examples, observing from the same perspective does not provide any additional information.

In some examples, the central unit C ascertains, e.g. on the basis of the above estimation, which part of the sensor data SD, e.g., raw data, is required by which sensor device and, for example, with which compression rate, e.g., data compression rate, the sensor data, e.g., raw data, should be compressed. In some examples, data compression can be achieved, for example, by filtering the sensor data, e.g., raw data, e.g. with a specifiable filter rate.

In some examples, the central unit C sends a corresponding request REQ-SD (see also FIG. 1) to at least some, for example all, sensor devices based on the above-described ascertainment of the required parts of the sensor data.

In some examples, the sensor devices that have received a request from the central unit C create a corresponding response and send the response to the central unit C. In some examples, based on the responses and, optionally, if applicable, additionally based on its own sensor data, the central unit C then generates output data characterizing an, e.g., accurate, observation of the region of interest or of the target object t of interest. In some examples, the output data can, e.g., be processed and forwarded to one or more users in the form of object lists or feature information.

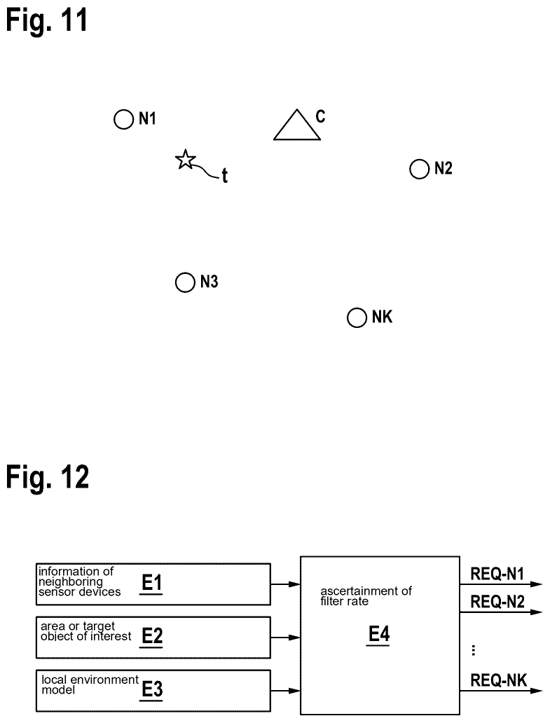

FIG. 12 schematically shows a simplified block diagram. Element E1 symbolizes information of neighboring sensor devices. Element E2 symbolizes an area or target object t of interest. Element E3 symbolizes a local environment model, as may be available, e.g., in the central unit C (FIG. 11). Element E4 symbolizes an ascertainment of a filter rate, e.g. for the sensor data, e.g., raw data, e.g. based on at least one of the elements E1, E2, E3. The arrows REQ-N1, REQ-N2, . . . , REQ-NK symbolize requests to the various sensor devices N1, N2, . . . , NK (FIG. 11), based, e.g., on the filter rate ascertained according to block E4. By means of these requests REQ-N1, REQ-N2, . . . , REQ-NK, the central unit C can thus, in some examples, specify in what manner or to what extent a data reduction should be carried out at the various sensor devices N1, N2, . . . , NK before correspondingly reduced sensor data are sent by the various sensor devices N1, N2, . . . , NK to the central unit C. In some examples, an individual filter rate can be specified, e.g., for each of the sensor devices N1, N2, . . . , NK.

Examples and aspects of ascertaining a filter rate for sensor data, for example raw data, are given below, which can be combined with at least one of the above aspects in further examples.

In some examples, a method is proposed to filter the spectrum detected, e.g., by means of the plurality of sensor devices, e.g. at least partially and, e.g. intelligently, e.g. in the sensor devices, e.g. for radar sensors or radar devices RE (FIG. 2) or ICAS, and, e.g., to share only the partial (e.g., most informative) spectrum with other sensor devices or the central unit C, e.g. of a detection cluster.

In the following, a method for determining a raw-data filter rate according to some examples is proposed. In further examples, methods other than the one described by way of example can be used to ascertain a filter rate.

In further examples, the determination of the filter rate can also be extended, e.g., to other sensor types than the radar devices RE (FIG. 2) or radar sensors, e.g., to camera devices KE, LIDAR devices LE, etc.

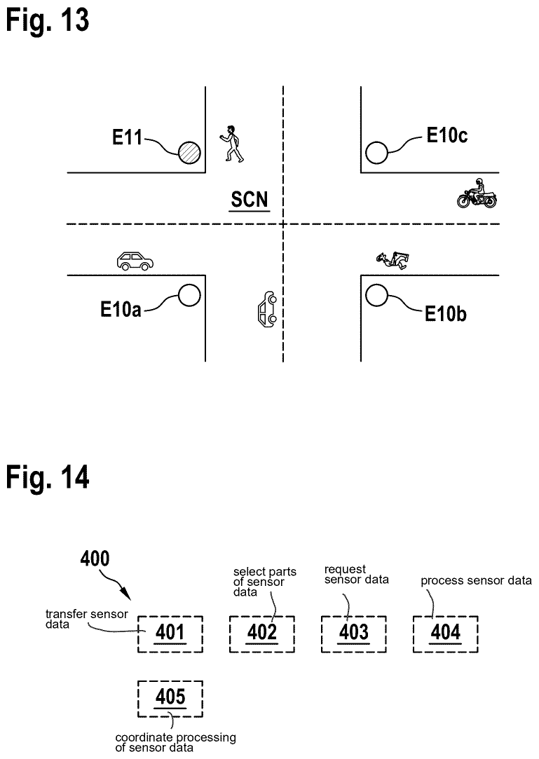

FIG. 13 schematically shows a simplified block diagram. The elements E10a, E10b, E10c symbolize sensor devices or products with sensor devices, for example arranged in the area of a road, e.g., as roadside units, which each detect a scene SCN associated with the road and provide the corresponding sensor data. For example, each sensor device perceives the environment from its own perspective. Element E11 symbolizes a central unit.

In some examples, whatever a sensor device perceives is ultimately associated with, i.e., e.g., from, a limited geometric observation perspective. For example, a radar device RE (FIG. 2) provides “maps” from a bird's eye view, e.g., as range-angle signatures at the Doppler spectrum level (range-angle-Doppler spectrum).

A sensor device that, for example, observes a pedestrian approaching the sensor device will, in some examples, ascertain different sensor data than a sensor device that observes the pedestrian, e.g., from a lateral or diagonal perspective.

In some examples, individual objects occupy, e.g., an area of signatures at the level of the range-angle-Doppler spectrum. This can be, e.g., a four-dimensional (4D) spectrum, i.e., range, azimuth angle, elevation angle, and Doppler, e.g., with predefined resolutions. In some examples, the resolutions in each dimension depend on radar hardware used in the relevant radar device and, e.g., on system parameter settings.

In some examples, e.g., the range resolutions and velocity resolutions depend on the system parameters, i.e., e.g., on a bandwidth or an observation duration. The angular resolution can, e.g., be influenced by radar hardware, e.g., provision of more antennas (e.g., horizontally, vertically, diagonally).

In some examples, it is assumed that a function exists, e.g., ƒ:R^{N×M×A}^{ₐ}^{×A}^{ₑ}→R⁴, which transforms an occupancy of the range-angle-Doppler spectrum (e.g., characterized by the sensor data, e.g., raw data) by a target object into information, e.g., at the object level. In some examples, this function can, e.g., be a clustering algorithm or an AI-based object detection network.

In some examples, an additional function is defined, e.g., for filtering raw data. By way of example, a spectrum observation of an i-th sensor device is defined as Sᵢ∈R^{N×M×A}^{ₐ}^{×A}^{ₑ}, where N characterizes a number of range bins (e.g., range classes), where M characterizes a number of Doppler bins (e.g., Doppler classes), where Aₐ characterizes a number of bins (e.g., classes) in an azimuth angle, where Aₑ characterizes a number of bins (e.g., classes) in an elevation angle.

In some examples, it is assumed that a function

$${g}_{j i}^{< t >} ,$$

∀j≠i,∀t exists that filters Sᵢ so that the function

$${g}_{j i}^{< t >}$$

removes the redundancy in the spectrum occupancy of the i-th target object of the j-th observation of a sensor device from the perspective of the j-th sensor device, ∀j≠i,∀t.

In some examples, it is assumed that, e.g. in a previous step, the observed spectra are clustered at the sensor devices. In some examples, this means that a certain spectral range at the sensor device SU i,Sᵢ^{<t>} represents the target object t.

In some examples, the function

$${g}_{j i}^{< t >}$$

implicitly minimizes a mutual item of information in the spectrum occupancy of the target t from the point of view of the sensor devices i and j, i.e.,

$$l ( {S}_{i}^{< {t}_{K} >} , {S}_{j}^{< {t}_{K} >} ) .$$

In some examples, design hints for the filter function

$${g}_{j i}^{< t >}$$

are suggested, e.g. per (i,j,k) tuple, ∀i≠j,∀k. With this filter function

$${g}_{j i}^{< t >} ,$$

e.g., a sensor device SU i can preprocess a spectrum observation (e.g., in the sense of a reduction, for example filtering) and can transmit the smallest volume of its raw data (spectrum occupancy) about the target object t to the further sensor device SU j, see, e.g., blocks 110, 112 according to FIG. 3.

Further exemplary aspects and information are provided below, which in some examples can be combined with at least one of the aspects and examples described above.

For the sake of simplicity and without loss of generality, some examples are limited to a signature of the range-Doppler spectrum. In some examples, it is assumed that, e.g., a dynamic object is located in the common detection range (e.g., field of view, FoV) of four sensor devices or sensing units (SUs). In some examples, it is further assumed that the following information is known to the four sensor devices:
The location of all sensor devices, e.g. in a two-dimensional (2D) coordinate system, —The position of the target objects at an object level (see, e.g., the above explanations on the function ƒ:R^{N×M×A}^{ₐ}^{×A}^{ₑ}→R⁴), —The velocity vector of the targets at the object level (see, e.g., the above explanations on the function ƒ: R^{N×M×A}^{ₐ}^{×A}^{ₑ}→R⁴).

In some examples, the position of the target object is defined as pₜ and the absolute velocity vector as vₜ. In some examples, the i-th SU position (i.e., position of the i-th sensor device) is defined as pᵢ; in this case, the relative normalized position vector is

$${n}_{i}^{< t >} = \frac{{p}_{t} - {p}_{i}}{‖ {p}_{t} - {p}_{i} ‖} .$$

In some examples, a state vector of the target object t at the object level is defined as sₜ. This state vector comprises, e.g., the position, velocity, acceleration, orientation, heading, class and all other target-relevant features of the target.

Methods for a shared use of a Doppler spectrum and range-angle spectrum between sensor devices are proposed according to further examples.

In some examples, Doppler spectrum sharing, i.e., a shared use of a Doppler spectrum, e.g., by a plurality of sensor devices, is proposed. In some examples, micro-Doppler signatures can help identify micro-movements of the target object, which, e.g., makes target classification much easier.

In some examples, it is assumed that the target object t radially approaches the sensor device (SU) i and radially withdraws from the sensor device SU j, i.e., radially distances itself from the sensor device SU j, e.g., according to

$${v}_{t}^{T} \cdot {n}_{i}^{< t >} = - {v}_{t}^{T} \cdot {n}_{j}^{< t >} .$$

This means that the relative radial velocity (i.e., e.g., what radar sensors perceive from an actual velocity) observed in SU i is likewise negative in SU j. This example provides the following insights:

In some examples, e.g., given that

$${v}_{t}^{T} \cdot {n}_{i}^{< t >} = - {v}_{t}^{T} \cdot {n}_{j}^{< t >} ,$$

the observation from SU i, does not improve feature extraction (from the spectrum) in SU j, i.e., h(sₜ|Sᵢ,Sⱼ)=h(sₜ|Sⱼ), where h(⋅) denotes the entropy.

In some examples, with two SUs located relatively close to one another, nᵢ≈nⱼ, the relative radial velocity observations are almost the same,

$${v}_{t}^{T} \cdot {n}_{i}^{< t >} = {v}_{t}^{T} \cdot {n}_{j}^{< t >} ;$$

in some examples with almost identical Doppler spectrum observations, no Doppler raw data would therefore be transferred, e.g.

In some examples where

$${v}_{t}^{T} \cdot {n}_{i}^{< t >} = 0$$

$$and$$

$${v}_{t}^{T} \cdot {n}_{j}^{< t >} \neq 0$$

apply, the target object t, e.g., as a dynamic object, is not detectable in SU i but is detectable in SU j. So if, e.g., Sⱼ is given in SU i, its estimate of sₜ can be improved.

In some examples, the aspects and findings described above can be considered, e.g., as an extreme case for a Doppler spectrum transfer rate between sensor devices (SUs). This Doppler spectrum transfer rate can be defined, e.g., as a function of vₜ, nᵢ, nⱼ, for example according to (1).

$${r}_{j i}^{< t >} = \frac{‖ {v}_{t}^{T} \cdot {n}_{j}^{< t >} \vert - \vert {v}_{t}^{T} \cdot {n}_{i}^{< t >} ‖}{‖ {v}_{t} ‖}$$

In some examples, the specified Doppler spectrum filter rate is not limited to the function specified above. Rather, in further examples, further functions can, e.g., be developed in order to detect the aspects and findings described above.

In some examples, sharing a range-angle spectrum, i.e., a shared use of the range-angle spectrum, e.g., by a plurality of sensor devices, is proposed.

In some examples, an observed range-angle spectrum is informative for geometry estimation of the target object (e.g., through bounding box extraction) and/or for classification and/or orientation estimation. However, with increasing range angle resolution (e.g., high bandwidth, more antennas), the range-angle spectrum can have more geometric signatures.

In some examples, the diversity of the range-angle spectrum depends only on the perspective of the SU (observation angle, FoV), e.g., in contrast to the Doppler spectrum. In some examples, this means that, regardless of the velocity of the target object, sufficient information from all viewing angles is available for accurate localization. In some examples, a range-angle filter rate can therefore be defined as a function of the normal vectors nᵢ of the SUs. For example, according to:

$${r}_{j i}^{< t >} = \frac{1 - {n}_{j}^{< t {>}^{T}} {n}_{i}^{< t >}}{2} . \qquad ( 2 )$$

In some examples, one or more of the above equations

$${r}_{j i}^{< t >} = \frac{‖ {v}_{t}^{T} \cdot {n}_{j}^{< t >} \vert - \vert {v}_{t}^{T} \cdot {n}_{i}^{< t >} ‖}{‖ {v}_{t} ‖} , \\ {r}_{j i}^{< t >} = \frac{1 - {n}_{j}^{< t {>}^{T}} {n}_{i}^{< t >}}{2}$$

can be evaluated, e.g., calculated, e.g. in at least one sensor device (SU), and, in some examples, the observed spectrum (e.g., characterizing the sensor data of the relevant sensor device) can then be filtered, e.g. on the basis of these calculated filter rates, e.g., at least similarly to FIG. 5, 6.

In some examples, a spectrum filtered, e.g., according to the above equations (1) or (2), can be transmitted to at least one further sensor device, e.g., a plurality of sensor devices provided for this purpose, e.g., in order to improve their estimation of a target state vector (sₜ) through fusion (e.g., all received spectra are merged with the SUs' own spectrum observation).

In some examples, the communication system KS (FIG. 2) is used as the communication interface for transferring the sensor data, e.g., filtered raw data.

In some examples, e.g., a first sensor device determines, e.g. based on the position of the other sensor devices and, e.g., after calculating the filter rate (e.g., according to equation (1) or (2)), from which other sensor device(s) it requires what volume of raw data. Then, e.g., the provided identities of the sensor devices (e.g., SU-IDs), e.g., with the filter rates per target, are communicated in request information, e.g., using at least one request according to the element REQ-SD of FIG. 1, 2.

In some examples, a request REQ-SD can be contained, e.g., in a separate container of a CPM or, e.g., be transferred as a separate message. In some examples, the message can, e.g., be formatted or sent as unicast, groupcast or broadcast. However, in some examples, the provided SU-ID should be specified for groupcast and broadcast.

Further examples, FIG. 14, relate to a use 400 of the method according to the examples and/or of the device 300 according to the examples and/or of the product 10, 10′, 20 according to the examples and/or of the computer-readable storage medium SM according to the examples and/or of the computer program PRG according to the examples and/or of the data carrier signal DCS according to the examples for at least one of the following elements: a) transferring 401 sensor data SD, for example raw data of at least one sensor device, or b) selecting 402 parts of sensor data SD, for example raw data, or c) requesting 403 sensor data SD, for example raw data, or d) processing 404, for example joint processing, of sensor data SD, for example raw data, for example of a plurality of sensor devices, or e) coordinating 405 a processing of sensor data, for example raw data, for example of a plurality of sensor devices.

1-17. (canceled)

18. A computer-implemented method for processing data associated with a sensor device to transfer the data in a wireless communication system, the method comprising the following steps:
receiving a request for transmitting sensor data of the sensor device to at least one further device, wherein the request characterizes at least one property of the sensor data;
providing the sensor data; and
sending the sensor data to the at least one further device.

19. The method according to claim 18, wherein the at least one property of the sensor data is and/or characterizes at least one of the following elements:
a) a part, or
b) degree of compression, or
c) temporal and/or spatial and/or spectral resolution.

20. The method according to claim 18, further comprising:
reducing, including filtering, the sensor data based on the request; and
sending the reduced sensor data.

21. The method according to claim 18, further comprising:
ascertaining a filter function based on the at least one property; and
using the filter function for a reduction of the sensor data.

22. The method according to claim 18, further comprising:
ascertaining a first filter rate for Doppler spectrum sharing; and
filtering the sensor data based on the first filter rate.

23. The method according to claim 18, further comprising:
ascertaining a second filter rate for range-angle spectrum sharing, and,
filtering the sensor data based on the second filter rate.

24. A computer-implemented method for processing data associated with a sensor device to transfer the data in a wireless communication system, comprising the following steps:
sending, to the sensor device, a request for transmitting sensor data of the sensor device to at least one further device, wherein the request characterizes at least one property of the sensor data;
receiving the sensor data; and
processing the received sensor data.

25. The method according to claim 24, wherein the at least one property of the sensor data is and/or characterizes at least one of the following elements:
a) a part, or
b) a degree of compression, or
c) a temporal and/or spatial and/or spectral resolution.

26. The method according to claim 24, further comprising:
forming the request based on at least one of the following elements:
a) information regarding neighboring sensor devices, or
b) a specifiable area of interest, or
c) an environment model; and
sending the request.

27. The method according to claim 24, further comprising:
forming a plurality of requests, each for different sensor devices, based on at least one of the following elements:
a) information regarding neighboring sensor devices, or
b) a specifiable area of interest, or
c) an environment model; and
sending the plurality of requests to the different sensor devices.

28. The method according to claim 27, further comprising:
receiving sensor data from the different sensor devices; and
jointly evaluating the received sensor data.

29. A device configured to processing data associated with a sensor device to transfer the data in a wireless communication system, the device configured to:
receive a request for transmitting sensor data of the sensor device to at least one further device, wherein the request characterizes at least one property of the sensor data;
provide the sensor data; and
send the sensor data to the at least one further device.

30. A non-transitory computer-readable storage medium on which are stored commands for processing data associated with a sensor device to transfer the data in a wireless communication system, the commands, when executed by a computer, causing the computer to perform the following steps:
receiving a request for transmitting sensor data of the sensor device to at least one further device, wherein the request characterizes at least one property of the sensor data;
providing the sensor data; and
sending the sensor data to the at least one further device.

31. The method according to claim 18, where in the method is used for at least one of the following elements:
a) transferring raw data of at least one sensor device, or
b) selecting parts of the raw data, or
c) request raw data, or
d) joint processing of raw data a plurality of sensor devices, or
e) coordinating a processing of raw data of a plurality of sensor devices.
